(19) United States
(12) Patent Application Publication
(10) Pub. No.: US 2016/0094590 A1
(43) Pub. Date: Mar. 31, 2016

(54) SYSTEM AND METHOD FOR CONFIGURING COMMUNICATION SESSION

(71) Applicant: giosg.com Oy, Helsinki (FI)

(72) Inventors: Tuomas Vainio, Espoo (FI); Mikael Taina, Espoo (FI); Joona Paakkonen, Espoo (FI); Ville-Matti Rissanen, Kantvik (FI); Kimmo Kuski, Helsinki (FI); Ari Niinimaki, Kirkkonummi (FI); Arsi Halttunen, Espoo (FI)

(21) Appl. No.: 14/501,742

(22) Filed: Sep. 30, 2014

(51) Int. Cl. H04L 29/06; G06Q 30/06

(52) U.S. Cl. CPC H04L 65/1069; G06Q 30/0617

(57) ABSTRACT

Disclosed is a system for configuring a communication session. The system comprises a plurality of operator devices associated with a plurality of sales operators. The system further comprises a server arrangement coupled via one or more communication networks to the plurality of operator devices. The server arrangement is operable to receive information pertaining to a web page that is accessed by a consumer device associated with a given consumer. The server arrangement is then operable to analyze the information to select an operator device from the plurality of operator devices. Moreover, the server arrangement is operable to start the communication session between the consumer device and the selected operator device.

### TECHNICAL FIELD

The present disclosure relates generally to systems and methods for facilitating online communications; and more specifically, to systems for configuring a communication session. Moreover, the present disclosure relates to computer-implemented methods for configuring a communication session. Furthermore, the present disclosure relates to computer program products comprising non-transitory computer-readable data storage media having stored thereon computer-readable program code, which is executable by a processor of a computing device to implement the aforesaid methods.

### BACKGROUND

Online shopping (namely, e-commerce) has become increasingly popular now-a-days. Currently, there are thousands of merchant websites (namely, web shops) offering various products and services for sale. Typically, such websites provide multiple product segments, for example, such as electronics, clothing, home furnishing, books, and so on. Each of these multiple product segments is typically associated with multiple product categories. As an example, product categories associated with a product segment ‘electronics’ could include televisions, smart phones, computers, washing machines, cameras, game consoles, and so on. Moreover, each of the multiple product categories is typically associated with multiple products offered by multiple brands. As a result, these websites include a large number of web pages, for example, including web pages associated with the product segments, the product categories, the products and/or the brands.

With a wide range of products available in the market today, consumers often get confused while making a selection of a product for purchase. In order to help such consumers, merchant websites typically employ a real time or a near real time online help system, for example, using a chat technology. Such a chat technology can be provided with the help of a code snippet, typically, added to a header section of HyperText Markup Language (HTML) codes defining a merchant website. When a consumer accesses the merchant website on a browser of a consumer device, the code snippet is configured to initiate a download of a Javascript, at the consumer device, using the browser of the consumer device. The Javascript configures a pop-up window, such as a chat window, over the merchant website. Subsequently, a sales operator associated with the merchant website interacts, via the chat window, with the consumer, and answers various queries of the consumer.

However, it is fairly challenging to employ such an online help system for answering consumer's queries to a desired extent. A problem with the conventional chat technology is that chats are always directed to a same sales operator, irrespective of the nature of queries of consumers. Moreover, it is not possible for the same sales operator to have a knowledge of all the products and various aspects thereof.

One way to employ multiple sales operators, for example, assigned to different web pages associated with different product segments or different product categories requires multiple different Javascripts for the different web pages. With hundreds and thousands of web pages in a single website, this approach is not feasible, as adding the multiple different Javascripts to the different web pages will require a substantial effort and maintenance work for a website administrator.

### SUMMARY

The present disclosure seeks to provide an improved system for configuring a communication session.

The present disclosure also seeks to provide an improved method for configuring a communication session.

A further aim of the present disclosure is to at least partially overcome at least some of the problems of the prior art, as discussed above.

In one aspect, embodiments of the present disclosure provides a system for configuring a communication session. The system comprises a plurality of operator devices associated with a plurality of sales operators. The system further comprises a server arrangement coupled via one or more communication networks to the plurality of operator devices.

The server arrangement is operable to receive information pertaining to a web page that is accessed by a consumer device associated with a given consumer. Further, the server arrangement analyzes the information to select an operator device from the plurality of operator devices. Moreover, the server arrangement is operable to start the communication session between the consumer device and the selected operator device.

In another aspect, embodiments of the present disclosure provide a method for configuring a communication session, the method comprising:

(a) downloading an executable code to a first computing device;
(b) collecting information from the first computing device using the executable code;
(c) communicating the information to a server arrangement;
(d) analyzing the information at the server arrangement;
(e) selecting, from a plurality of addresses, an address for communication, based at least partially on said analysis of the information; and
(f) starting the communication session between the first computing device and a second computing device, the second computing device being associated with the address for communication.

In yet another aspect, embodiments of the present disclosure provide a computer program product comprising a non-transitory computer-readable data storage medium having stored thereon computer-readable program code, which is executable by a processor of a computing device to implement the aforementioned method.

Embodiments of the present disclosure substantially eliminate or at least partially address the aforementioned problems in the prior art, and enable configuration of a communication session between a consumer and a sales operator, who is capable of answering the consumer's queries to a desired extent.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a network environment that is suitable for practicing embodiments of the present disclosure;

FIG. 2 is a schematic illustration of an example scenario for establishing a communication session; in accordance with an embodiment of the present disclosure;

FIG. 3 is a schematic illustration of a flow diagram depicting various steps of a method for configuring a communication session, in accordance with an embodiment of the present disclosure;

FIG. 4 is an illustration of steps of a method for configuring a communication session, in accordance with an embodiment of the present disclosure; and

FIG. 5 is a schematic illustration of an example user interface, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, embodiments of the present disclosure provide a system for configuring a communication session. The system comprises a plurality of operator devices associated with a plurality of sales operators. The system also comprises a server arrangement coupled via one or more communication networks to the plurality of operator devices.

The server arrangement is operable to receive information pertaining to a web page that is accessed by a consumer device associated with a given consumer. The server arrangement analyzes the information to select an operator device from the plurality of operator devices. The server arrangement is operable to start the communication session between the consumer device and the selected operator device.

In an embodiment, the system is implemented in an e-commerce environment. The e-commerce environment pertains to a merchant website that includes multiple web pages associated with various products and services that are being offered for sale on the merchant website. Optionally, the merchant website includes a plurality of product segments, wherein one or more of the plurality of product segments is associated with a plurality of product categories, and further wherein one or more of the plurality of product categories is associated with a plurality of products offered by a plurality of brands. Additionally, optionally, one or more of the plurality of brands offer different products that are associated with different product segments and/or product categories. As an example, a brand ‘Brand X’ could offer smart phones, computers, washing machines, cameras and so on. As a result, the merchant website includes a plurality of web pages, for example, including web pages associated with the product segments, the product categories, the products and/or the brands.

In an example, the merchant website could include product segments, such as electronics, clothing, bikes, tools, books and the like. Moreover, product categories associated with a product segment ‘electronics’ could include televisions, smart phones, computers, washing machines, cameras, game consoles and the like. Furthermore, products offered under a product category ‘televisions’ could include televisions from brands ‘Brand X’, ‘Brand Y’, ‘Brand Z’ and so on.

In another example, the merchant website is a travel website that offers various travel and tour packages to the consumers. In this example, the travel and tour packages could be associated with various geographies, activities and the like.

Throughout the present disclosure, the terms “consumer” and “visitor” generally refer to a user who accesses a merchant website, and visits one or more web pages of the merchant website. The term “consumer device” refers to a computing device associated with a consumer, through which the consumer accesses the merchant website. Examples of the consumer device include, but are not limited to, a mobile phone, a smart telephone, a Mobile Internet Device (MID), a tablet computer, an Ultra-Mobile Personal Computer (UMPC), a phablet computer, a Personal Digital Assistant (PDA), a web pad, a Personal Computer (PC), a handheld PC, a laptop computer, a desktop computer, and a large-sized touch screen with an embedded PC.

Moreover, the term “sales operator” generally refers to an expert, who has a knowledge of one or more products and various features thereof. The sales operators can be from a single company or from different companies or organisations. A single sales operator may be having simultaneously several communication sessions with different consumers. The different consumers may even be accessing different web pages, even web pages of different providers, such as different online shops. Similarly, a single web page may provide communication sessions with different sales operators, the different sales operators possibly representing different companies or organisations.

The term “operator device” refers to a computing device associated with a sales operator, through which the sales operator communicates with a consumer over a communication session. Examples of the operator device include, but are not limited to, a mobile phone, a smart telephone, an MID, a tablet computer, a UMPC, a phablet computer, a PDA, a web pad, a PC, a handheld PC, a laptop computer, a desktop computer, and a large-sized touch screen with an embedded PC.

Moreover, the server arrangement typically includes one or more servers and one or more databases associated with the one or more servers.

Moreover, the consumer device and the plurality of operator devices are typically coupled to the server arrangement via one or more communication networks. Such communication networks can be wired, wireless, or a combination thereof. Examples of such communication networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

The server arrangement is operable to receive information pertaining to a web page that is visited by a consumer, namely a web page that is rendered on a consumer device associated with the consumer. In an example, the consumer may have visited the web page while searching for a product or service. Thus, the web page could be related to a specific product or service offered for purchase on the merchant website.

In an example, the web page includes a code snippet in a HyperText Markup Language (HTML) code of the web page. The code snippet may, for example, be included in a header section of the HTML code by a website administrator or developer of the website. A person skilled in the art will recognize that web page content is typically defined with HTML codes.

The code snippet causes a web browser of the consumer device to download an executable code from the server arrangement. In an example, the executable code is a Javascript.

Optionally, as the HTML code is rendered, the web browser uses an internal model that represents a Document Object Model (DOM) tree of the website. The term “DOM” generally refers to a tree structure in which nodes of every document in a web page are organized.

Optionally, the executable code is configured to make a Cascading Style Sheets (CSS) selector script. Accordingly, the executable code is configured to go through the DOM tree and collect information related to the web page rendered on the consumer device (hereinafter referred to as “web page information”).

Optionally, the information is derived from a content of the web page. The information can, for example, include one or more of: textual information, information about images and/or videos present on the web page, header information, and/or information about keywords in the HTML content of the web page. The textual information can, for example, include one or more keywords found on the web page. In an example, the one or more keywords found on the web page include brand names of products sold on the web page.

Additionally, optionally, the information can also include information of a shopping cart associated with the consumer. The information of the shopping cart can, for example, include a number of items in the shopping cart and/or a total cost of the items in the shopping cart. For illustration purposes only, an example of the executable code has been presented below:

<script>
(function(w, t, f) {
var
s=‘script’,o=‘_giosg’,e,n;e=t.createElement(s);e.async=1;e.src=
‘https://service.giosg.com/client/’+f+‘/’;
w[o]=w[o]||function( ){(w[o]._e=w[o]._e||[ ]).push(arguments)};
n=t.getElementsByTagName(s)[0];n.parentNode.insertBefore(e,n);
})(window,document, 32187213);
</script>

In the above example, the executable code includes a numeral ‘32187213’, which represents an identification code of the rendered web page. Such an identification code is communicated to the server arrangement to facilitate a same communication session to be opened for the consumer.

Moreover, the executable code is configured to communicate the web page information to the server arrangement prior to starting the communication session. This allows the server arrangement to determine with which sales operator the communication session is to be started.

In this regard, the server arrangement is operable to analyze the web page information, and to select a sales operator from the plurality of sales operators based at least partially on the analysis of the web page information. Consequently, the server arrangement is operable to start a communication session between the consumer and the selected sales operator. According to one embodiment, a sales operator associated with the selected operator device is an expert associated with the information.

Optionally, the server arrangement is operable to analyze the web page information based on a predetermined set of rules for selecting the sales operator.

In an embodiment, the analysis of the web page information is word based. Optionally, when analyzing the web page information, the server arrangement is operable to compare one or more keywords found on the web page with one or more keywords stored at the server arrangement, such as at the one or more databases thereof. Optionally, the one or more keywords stored at the server arrangement are associated with the plurality of sales operator. The one or more keywords found on the web page may thus comprise brand names of products sold on the web page.
In another embodiment, the analysis of the web page information is based on comparing the actual time at the sales operators location with opening times of the sales operators. Indeed, if no sales operators are present at the particular time, the communication session can be started with a third party from which communication session services are purchased for such times. Any other such set of rules may be used, in addition or in place of those mentioned here.
In yet another embodiment, the analysis of the web page information is based on an analysis of the communication history of the consumer device, when the same consumer device has visited the web page previously. The analysis may also be based on an analysis of internet protocol (IP) information of the consumer device, such as country and city. According to yet another embodiment, the analysis can be based further on an analysis of the content and value of a shopping cart, for example in number of items as well as their total value. Such an analysis may be independent of the source of the information (such as the web page itself or another information system). The analysis of the web page information may thus be rather freely based on different information.

For example, if the web page includes a keyword ‘Samsung’ (Samsung is a registered trademark), the server arrangement searches for the keyword ‘Samsung’ in the one or more keywords stored at the databases. If, for example, the keyword ‘Samsung’ is found to be associated with a particular sales operator, the server arrangement selects that particular sales operator for the communication session.

In another embodiment, the analysis of the web page information is context based. In this regard, a context of the content of the web page and its meanings are analyzed by the server arrangement to identify a sales operator associated with the context. For example, if the web page information includes textual subject matter related to terms and conditions of the website, the server arrangement selects a sales operator having a legal background.

In yet another embodiment, the analysis of the web page information is performed based on an expertise of the sales operators. Optionally, detailed profiles of the plurality of sales operators are stored at the one or more databases of the server arrangement. Optionally, a profile of a given sales operator includes at least one of: a skill set of the given sales operator, a rating of the given sales operator, one or more brands with which the given sales operator is associated, and/or one or more product categories of which the given sales operator is an expert. Thus, optionally, the server arrangement selects a sales operator, whose detailed profile matches with the web page information.

In still another embodiment, the analysis of the web page information is performed based on the information of the shopping cart associated with the consumer. For example, if a number of items in the shopping cart exceeds a predefined threshold number or a total cost of the items exceeds a predefined threshold cost, the server arrangement selects a specialized sales operator to provide a VIP service to the consumer. The predefined threshold number and the predefined threshold cost may be defined by a system administrator.

In yet another embodiment, the analysis of the web page information is performed based on a profile of the consumer. The profile of the consumer may, for example, indicate whether or not the consumer is a premium consumer. In an example, if the consumer is identified as a gold card member of an airline, the server arrangement may select an experienced sales operator to answer queries from the consumer. Typically, the queries can be related to various aspects of a product, for example, such as a cost, an availability, a delivery time, technical specifications and the like.

Moreover, optionally, as each sales operator is associated with his/her own operator device, the server arrangement also stores addresses of the operator devices associated with the sales operators. In one example, an address of an operator device can be an Internet Protocol (IP) address of the operator device. In another example, the address can be a web address, such as a Uniform Resource Locator (URL) of the operator device. When the server arrangement selects a particular sales operator, an address associated with that particular sales operator is selected for communication.

Furthermore, in an embodiment, the communication session is a chat session. As the chat session is initiated between the consumer and the selected sales operator, a chat window pops up and is rendered on a user interface of the consumer device.

The chat window can be either non-transparent or semi-transparent. Moreover, optionally, the chat window can be moved by the consumer to an appropriate position on the user interface. Alternatively, optionally, the chat window can be pinned to an appropriate position on the user interface, for example, as defined by the system administrator of the website. Moreover, optionally, a size of the chat window can be user-adjustable. Optionally, the user interface includes a “chat” button that, when pressed by the consumer, launches the chat window.

Optionally, the chat session facilitates a textual communication between the consumer and the selected operator. Additionally or alternatively, optionally, the chat session facilitates audio and/or video communication between the consumer and the selected operator. For this purpose, the consumer device and the plurality of operator devices can have required hardware, for example, including microphones and speakers for audio communication and cameras for video communication.

Furthermore, it is to be noted here that the system can be implemented for configuring a communication session in a non-e-commerce environment as well. For example, the system can be implemented with respect to an informative website that is associated with a huge amount of study and research materials. Examples of such informative websites include, but are not limited to, ScienceDirect and IEEE Xplore. When a visitor accesses such an informative website to search for some information related to a particular technology domain, the system establishes a communication session between the visitor and an expert (similar to a sales operator in an e-commerce environment) in that particular technology domain. This potentially helps the visitor to search for the desired information in a convenient and efficient manner. It is to be noted here that the system can be implemented with other non e-commerce environments related to other exhaustive information websites related to various fields, for example, such as sports, dance, music and the like.

In an embodiment, the system as explained hereinabove is implemented in a client-to-server architecture. In an alternative embodiment, the system can be implemented in a client-to-client architecture, namely a peer-to-peer architecture. In such a case, the functionality of the server arrangement is implemented in at least some of the plurality of operator devices.

In another aspect, embodiments of the present disclosure provide a computer-implemented method for configuring a communication session, the method comprising:

(a) downloading an executable code to a first computing device;
(b) collecting information from the first computing device using the executable code;
(c) communicating the information to a server arrangement;
(d) analyzing the information at the server arrangement;
(e) selecting, from a plurality of addresses, an address for communication, based at least partially on said analysis of the information; and
(f) starting the communication session between the first computing device and a second computing device, the second computing device being associated with the address for communication.

According to an embodiment, a first user of the first computing device is a visitor to a web page, and a second user of the second computing device is an expert associated with the information.

According to an embodiment, the information is analyzed based on a predetermined set of rules, for example, as described earlier.

According to an embodiment, the information is derived from a content of a web page. Further, the information may pertain to one or more keywords found on the web page.

Optionally, in the method, the analyzing the information comprises comparing one or more keywords found on the web page with one or more keywords stored at the server arrangement. Moreover, optionally, the one or more keywords found on the web page comprise brand names of products sold on the web page.

According to an embodiment, the executable code is a Javascript.

According to an embodiment, the communication session is a chat session.

In yet another aspect, embodiments of the present disclosure provide a computer program product comprising a non-transitory computer-readable data storage medium having stored thereon computer-readable program code, which is executable by a processor of a computing device to implement the aforementioned method.

The present disclosure provides a system, a method and a computer program product for configuring a communication session between a consumer and a sales operator. Specifically, the communication session is facilitated based at least partially on information of a web page visited by the consumer. As the sales operator is selected based on the information of the web page, the sales operator is able to answer consumer's queries promptly. Thus, the communication session enables the consumer to have a fair idea about a product or service the consumer is planning to buy, and enables the sales operator to convert a potential consumer into a real consumer. Furthermore, this potentially enables a merchant, who owns the web page, to have better business prospects, because customers are directed to appropriate sales operators.

### DETAILED DESCRIPTION OF THE DRAWINGS

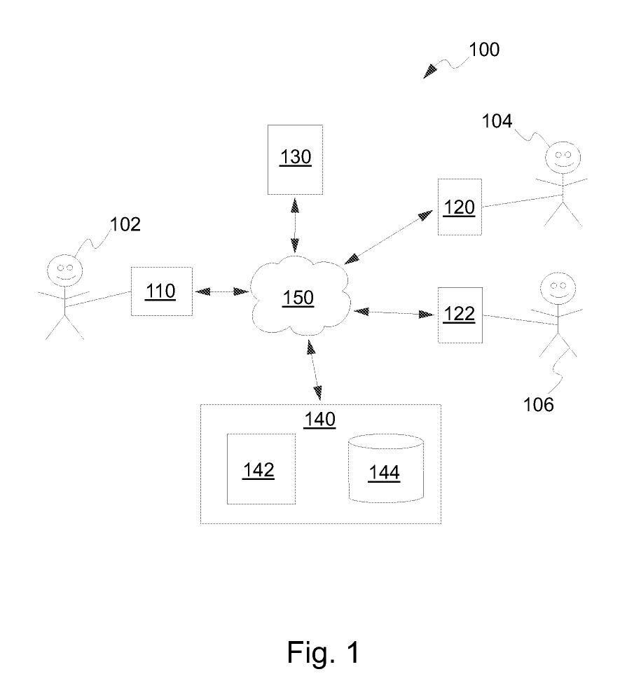

Referring now to the drawings, particularly by their reference numbers, FIG. 1 is a schematic illustration of a network environment 100 that is suitable for practicing embodiments of the present disclosure. The network environment 100 includes a consumer device 110 associated with a consumer 102, an operator device 120 associated with a sales operator 104, an operator device 122 associated with a sales operator 106. The network environment 100 also includes a website service 130 and a server arrangement 140. The server arrangement 140 includes one or more servers and one or more databases associated therewith, depicted as a server 142 and a database 144 in FIG. 1. The network environment 100 also includes one or more communication networks, depicted a communication network 150 in FIG. 1.

The communication network 150 communicatively couples the consumer device 110 with the website service 130 and the server arrangement 140. In addition, the communication network 150 communicatively couples the operator devices 120 and 122 with the server arrangement 140.

For illustration purposes only, let us consider that the consumer 102, accesses a web page available from the website service 130, for example, using a web browser of the consumer device 110.

A code snippet in the web page causes the web browser to download an executable code from the server arrangement 140. The executable code collects information related to the content of the web page and communicates the collected information to the server arrangement 140.

Subsequently, the server arrangement 140 analyzes the collected information to select an operator device from amongst the operator devices 120 and 122. Thereafter, a communication session is started between the consumer device 110 and the selected operator device.

FIG. 1 is merely an example, which should not unduly limit the scope of the claims herein. It is to be understood that the specific designation for the network environment 100 is provided as an example and is not to be construed as limiting the network environment 100 to specific numbers, types, or arrangements of consumer devices, operator devices, website services, servers and databases. A person skilled in the art will recognize many variations, alternatives, and modifications of embodiments of the present disclosure.

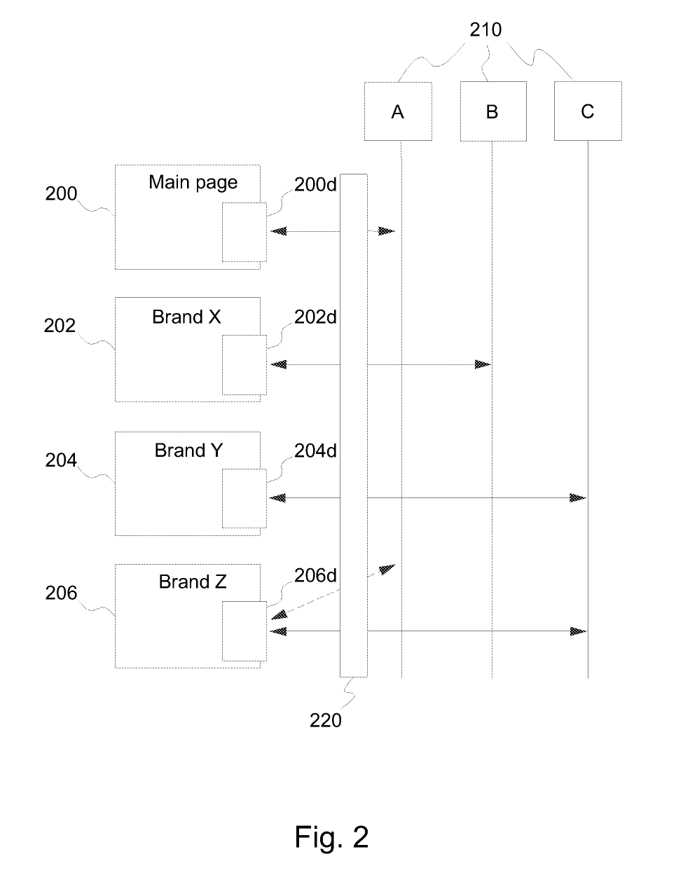

Referring now to FIG. 2, there is shown a schematic illustration of an example scenario for establishing a communication session, in accordance with an embodiment of the present disclosure. In FIG. 2, there are shown various web pages of a website, depicted as a main web page 200 and other web pages 202, 204 and 206.

In the example scenario, the web pages 202, 204, 206 are related to different brands that offer various products on the website, namely ‘Brand X’, ‘Brand Y’ and ‘Brand Z’, respectively. Moreover, the web pages 200, 202, 204 and 206 include chat windows 200d, 202d, 204d and 206d, respectively, as shown in FIG. 2.

In FIG. 2, there are also shown a plurality of sales operators 210, namely sales operators A, B and C, and a server arrangement 220.

For illustration purposes only, let us consider that the sales operator A is a general sales operator responsible for handling communications related to the main page 200. The main page 200 typically includes general information about the website. Therefore, the server arrangement 220 selects the sales operator A to handle a communication session on the chat window 200d of the main page 200. Accordingly, the chat window 200d pops up, when the consumer accesses the main page 200, to establish the communication session between the sales operator A and the consumer.

Moreover, in the example scenario, the sales operators B and C are sales representatives responsible for handling communications related to the brands ‘Brand X’ and ‘Brand Y’, respectively. As the web page 202 includes information associated with the brand ‘Brand X’, the server arrangement 220 selects the sales operator B to handle a communication session on the chat window 202d of the web page 202. Similarly, as the web page 204 includes information associated with the brand ‘Brand Y’, the server arrangement 220 selects the sales operator C to handle a communication session on the chat window 204d of the web page 204.

In the example scenario, let us also consider that there is no specific sales operator for the brand ‘Brand Z’, and the sales operator C has a general knowledge about a product category that is associated with the web page 206. As a result, the server arrangement finds the sales operator C to be a best match for the web page 206, and selects the sales operator C to handle a communication session on the chat window 206d of the web page 206. Alternatively, the server arrangement 220 can select the general sales operator A to handle the communication session on the chat window 206d of the web page 206, for example, when no relation can be identified between the information of the web page 206 and any of the sales operators A, B and C.

FIG. 2 is merely an example, which should not unduly limit the scope of the claims herein. A person skilled in the art will recognize many variations, alternatives, and modifications of embodiments of the present disclosure.

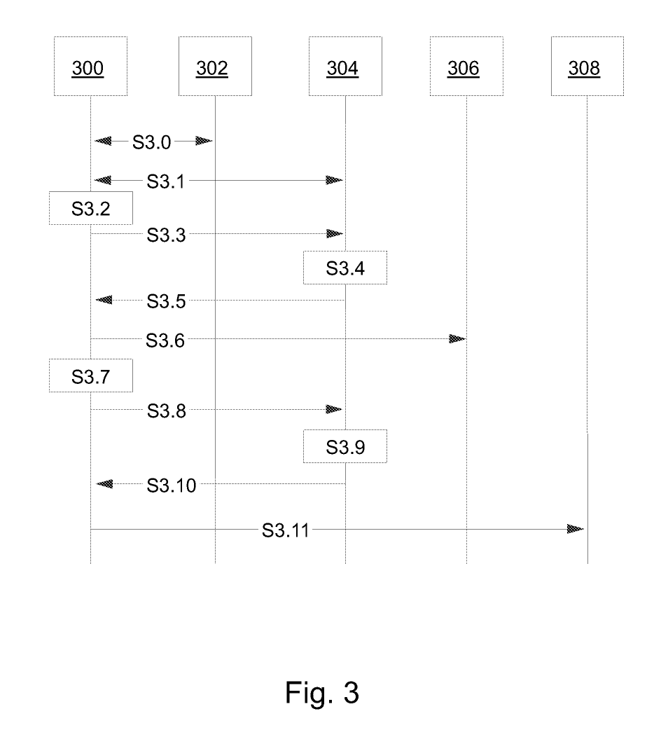

Referring now to FIG. 3, there is shown a schematic illustration of a flow diagram depicting various steps of a method for configuring a communication session, in accordance with an embodiment of the present disclosure.

At a step S3.0, a consumer associated with a consumer device 300 accesses a web page 302.

At a step S3.1, a web browser at the consumer device 300 downloads an executable code from a server arrangement 304.

At a step S3.2, the executable code collects information of the web page 302.

At a step S3.3, the information of the web page 302 is communicated to the server arrangement 304.

At a step S3.4, the server arrangement 304 analyzes the information to select a sales operator from a plurality of sales operators associated with operator devices 306 and 308.

At a step S3.5, the server arrangement 304 starts a communication session between the consumer device 300 and the operator device 306.

At a step S3.6, the consumer device 300 communicates with the operator device 306.

At a step S3.7, the consumer interacts with the web page 302. In one example, the consumer may click on a web link to visit a new web page. In another example, the consumer may add an item to a shopping cart.

At a step S3.8, new information about possible changes to the web page 302 or the new web page visited by the consumer at the consumer device 300 is communicated to the server arrangement 304.

At a step S3.9, the server arrangement 304 analyzes the new information for configuring a new communication session for the consumer.

At a step S3.10, the server arrangement 304 starts the new communication session between the consumer device 300 and the operator device 308.

At a step S3.11, the consumer device 300 communicates with the operator device 308.

FIG. 3 is merely an example, which should not unduly limit the scope of the claims herein. A person skilled in the art will recognize many variations, alternatives, and modifications of embodiments of the present disclosure.

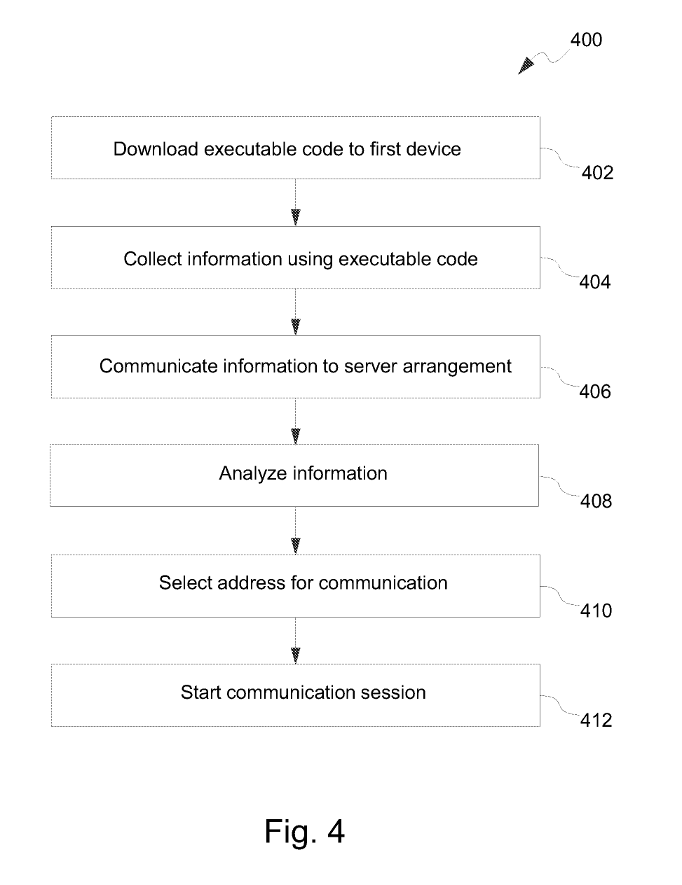

Referring now to FIG. 4, there is shown an illustration of steps of a method 400 for configuring a communication session, in accordance with an embodiment of the present disclosure.

At a step 402, an executable code is downloaded at a first computing device. In this embodiment, the executable code is a Javascript. Moreover, a first user of the first computing device can be a visitor to a web page.

At a step 404, information is collected from the first computing device using the executable code downloaded at the step 402. In this embodiment, the information is derived from a content of the web page.

At a step 406, the information collected at the step 404 is communicated to a server arrangement.

At a step 408, the information is analyzed at the server arrangement. In accordance with the step 408, the information is analyzed based on a predetermined set of rules.

Optionally, the step 408 includes a sub-step at which one or more keywords found on the web page are compared with one or more keywords stored at the server arrangement.

At a step 410, the server arrangement selects, from a plurality of addresses, an address for communication. The address for communication is associated with a second computing device. In this embodiment, a second user of the second computing device is an expert associated with the information.

The step 410 is performed based at least partially on the aforesaid analysis of the information.

At a step 412, the server arrangement starts the communication session between the first computing device and the second computing device.

The steps 402 to 412 are only illustrative and other alternatives can also be provided where one or more steps are added, one or more steps are removed, or one or more steps are provided in a different sequence without departing from the scope of the claims herein.

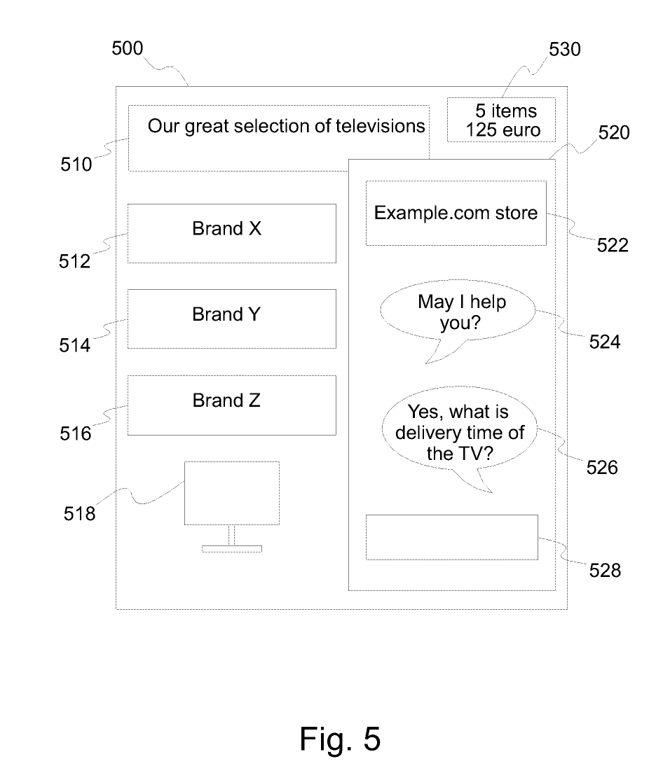

Referring now to FIG. 5, there is shown a schematic illustration of an example user interface 500, in accordance with an embodiment of the present disclosure. The user interface 500 is rendered at a display of a consumer device. A software application running on the consumer device is configured to control the user interface 500.

The user interface 500 displays a web page being accessed by a consumer associated with the consumer device. The user interface 500 displays a title 510 of the web page.

The user interface 500 also displays user-selectable items 512, 514 and 516. The user selectable items 512, 514 and 516 can be web links associated with brands ‘Brand X’, ‘Brand Y’ and ‘Brand Z’.

The user interface 500 also displays an image and/or video 518 of a given product that is offered for sale on the web page.

The user interface 500 also displays a shopping cart indicator 530. The shopping cart indicator 530 shows a number of products selected by the consumer and a total cost associated with the selected products. The shopping cart indicator 530 can also be a web link that can be used to check out from an online store associated with the web page.

The user interface 500 further displays a chat window 520. The chat window 520 shows a title 522 of the chat window 520. The title 522 may provide information about a sales operator with which a communication session is started via the chat window 520.

The chat window 520 also shows communications 524 and 526 between the consumer and the sales operator.

The chat window 520 includes an input dialogue box 528 that allows the consumer to write a text related to future communications.

FIG. 5 is merely an example, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for configuring a communication session, the system comprising:
a plurality of operator devices associated with a plurality of sales operators; and
a server arrangement coupled via one or more communication networks to the plurality of operator devices, wherein the server arrangement is operable to receive information pertaining to a web page that is accessed by a consumer device associated with a given consumer, and to analyze the information to select an operator device from the plurality of operator devices,
further wherein the server arrangement is operable to start the communication session between the consumer device and the selected operator device.

2. A system of claim 1, wherein a sales operator associated with the selected operator device is an expert associated with the information.

3. A system of claim 1, wherein the server arrangement is operable to analyze the information based on a predetermined set of rules.

4. A system of claim 1, wherein the server arrangement is operable to
compare one or more keywords found on the web page with one or more keywords stored at the server arrangement,
analyse communication history of the consumer device,
analyse internet protocol information of the consumer device,
analyse content and value of a shopping cart and/or
compare actual time with opening times of the sales operators,
when analysing the information.

5. A system of claim 4, wherein the one or more keywords found on the web page comprise brand names of products sold on the web page.

6. A system of claim 1, wherein the communication session is a chat session.

7. A system of claim 1, wherein the information is derived from a content of the web page.

8. A system of claim 1, wherein the information pertains to one or more keywords found on the web page.

9. A method for configuring a communication session, the method comprising:
(a) downloading an executable code to a first computing device;
(b) collecting information from the first computing device using the executable code;
(c) communicating the information to a server arrangement;
(d) analyzing the information at the server arrangement;
(e) selecting, from a plurality of addresses, an address for communication, based at least partially on said analysis of the information; and
(f) starting the communication session between the first computing device and a second computing device, the second computing device being associated with the address for communication.

10. A method of claim 9, wherein a first user of the first computing device is a visitor to a web page, and a second user of the second computing device is an expert associated with the information.

11. A method of claim 9, wherein the information is analyzed based on a predetermined set of rules.

12. A method of claim 9, wherein the analyzing the information comprises comparing one or more keywords found on a web page with one or more keywords stored at the server arrangement.

13. A method of claim 12, wherein the one or more keywords found on the web page comprise brand names of products sold on the web page.

14. A method of claim 9, wherein the executable code is a Javascript.

15. A method of claim 9, wherein the communication session is a chat session.

16. A method of claim 9, wherein the information is derived from a content of a web page.

17. A method of claim 9, wherein the information pertains to one or more keywords found on the web page.

18. A computer program product comprising a non-transitory computer-readable data storage medium having stored thereon computer-readable program code, which is executable by a processor of a computing device to implement a method of claim 9.
